(19) United States
(12) Patent Application Publication
(10) Pub. No.: US 2010/0053968 A1
(43) Pub. Date: Mar. 4, 2010

(54) Light housing for exhaust hood

(76) Inventor: Martin P. Burns, Forked River, NJ (US)

Correspondence Address: Francis C. Hand, Esq.,;c/o Carella, Byrne, Bain, Gilfillan, Cecchi,, Stewart & Olstein, 5 Becker Farm Road, Roseland, NJ, 07068, US

(21) Appl. No.: 12/231,377

(22) Filed: Sep. 2, 2008

(51) Int. Cl. F21V 33/00

(52) U.S. Cl. 362/253

(57) ABSTRACT

The housing is provided with two key-shaped slots with the larger end of each slot located in a clockwise direction relative to the smaller end of the slot. Rotation of the mounting screws while in the smaller portions of the slots imparts a clockwise rotation to the housing to abut the housing against the shanks of the mounting screws.

This invention relates to an incandescent light housing for an exhaust hood.

As is known, commercial kitchen ventilation hoods include hoods that are used over cooking equipment that produce heat and grease in order to draw off the air above the cooking surface of the cooking equipment. These hoods may be of a wall canopy type that is used when cooking equipment is placed against the wall or of a single island or double island type that is placed over one or more rows of cooking equipment where no walls exist. In each case, the hoods are made of a sheet metal and are fitted with pre-wired incandescent light fixtures and plastic-coated or non-plastic coated glass globes in order to illuminate the cooking surface.

Typically, the light fixture includes a housing that is mounted within the hood by two screws that pass through key-shaped slots in the fixture. These slots are sized with a larger opening at one end to fit over the head of the screws and a smaller opening at the opposite end for placement under the head of the screws upon rotation of the housing. In order to mount the housing in the hood, the larger ends of the slots are aligned with the screws and the housing is moved against the hood. Thereafter, the housing is rotated counter-clockwise relative to the hood to position the shanks of the screws in the smaller openings of the slots and, then, the screws tightened, i.e. rotated in a clockwise direction, to bring the head of the screws against the housing to hold the housing in place against the hood in a clamped manner.

However, as the screws are tightened down, the screws contact the housing and cause a clockwise rotation of the housing relative to the hood due to the frictional forces developed between the head of the screws and the housing. As a result, the heads of the screws approach the larger ends of the slots. In some cases where the screws become aligned with the larger ends of the slots, the housing may fall away from the hood. This requires the installer to repeat the installation process.

Since the light fixtures are typically recessed within a hood, the mounting of the housing within the hood can be cumbersome for an installer. In addition, in some cases where the housing of a light fixture was provided with holes and screws were passed through the hood and the holes in the housing to secure the housing in place, two people were used to install the fixture, one person in front of the hood and one person in back of the hood. In these cases, one person would not be able to pass the screws through the hood from outside the hood and at the same time hold the fixture in position within the hood for passage of the screws through the housing of the fixture.

In addition, when an incandescent light bulb is mounted in the housing, a clockwise rotation and tightening of the bulb in place may cause a clockwise rotation of the housing should the housing not be firmly fixed in place. Likewise, when a globe is mounted in the housing, there is typically a rotation of the globe in a clockwise direction. As a result of these rotations, the heads of the screws may become aligned with the larger openings in the slots thereby causing the fixture to separate from the hood. Thus, the installer must then remove the globe and attempt to re-mount the fixture on the screws thereby repeating the installation process and wasting time in the effort.

Further, during use, when an incandescent light bulb has burned out and requires replacement, unthreading of the globe and bulb from the housing and threading of a new bulb and the globe into the housing can cause further inadvertent rotations of the housing. In such cases, the housing may become separated from the hood and may fall out of the hood being supported only by the electrical wiring to the housing.

Where the hoods are provided with ventilation fans, the vibration of such fans may cause a lighting fixture housing that is not securely mounted to slowly rotate over time in a clockwise direction and become separated from the mounting screws. In such cases, the entire fixture and globe may separate from the hood and fall out of the hood being supported solely by the wiring to the housing.

Accordingly, it is an object of the invention to mount an incandescent light housing within an exhaust hood in a secure manner.

It is another object of the invention to reduce the risk of an incandescent light housing in an exhaust hood coming loose during operation.

Briefly, the invention provides an incandescent light housing which can be mounted in an exhaust hood via a pair of mounting screws wherein the housing has a base including a pair of key-shaped slots.

In accordance with the invention, each slot has an enlarged first portion of a size to permit passage of the head of the screw and a smaller second portion of a size to permit passage of the shank of the screw while preventing passage of the head. Further, the enlarged first portion is directed in a clockwise direction relative to the smaller second portion.

During fitting of the incandescent light housing into the exhaust hood, the housing is fitted over the two mounting screws by passing the heads of the screws through the larger first portions of the slots and then rotating the housing clockwise so as to locate the shanks of the screws in the smaller portions of the slots. The screws are then tightened by rotating in a clockwise direction. As the screw heads contact the housing, continued rotation of the screws imparts a frictional force onto the housing that directs the housing in a clockwise manner. This insures that the shanks of the screws remain firmly within the smaller portions of the slots.

The housing also has a threaded socket for receiving an incandescent light bulb and a depending annular collar that is concentric to the socket for receiving a globe. The collar is provided internally with a partial thread in order to receive the globe in a threaded manner. For example, the globe may be initially fitted into the collar and then rotated clockwise for several revolutions.

These and other objects and advantages of the invention will become more apparent from the following detailed description taken in conjunction with the accompanying drawings wherein

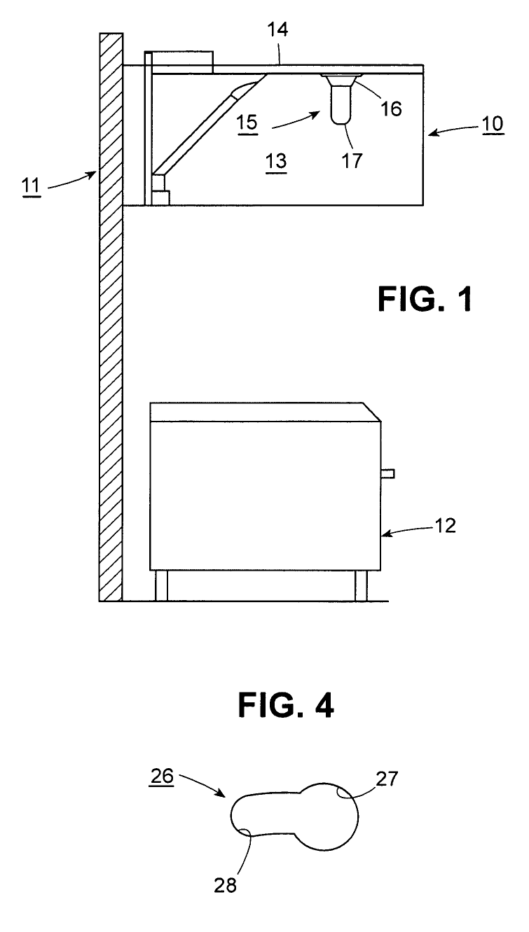

FIG. 1 illustrates a part cross-sectional view of a canopy type hood mounted over a cooking stove;

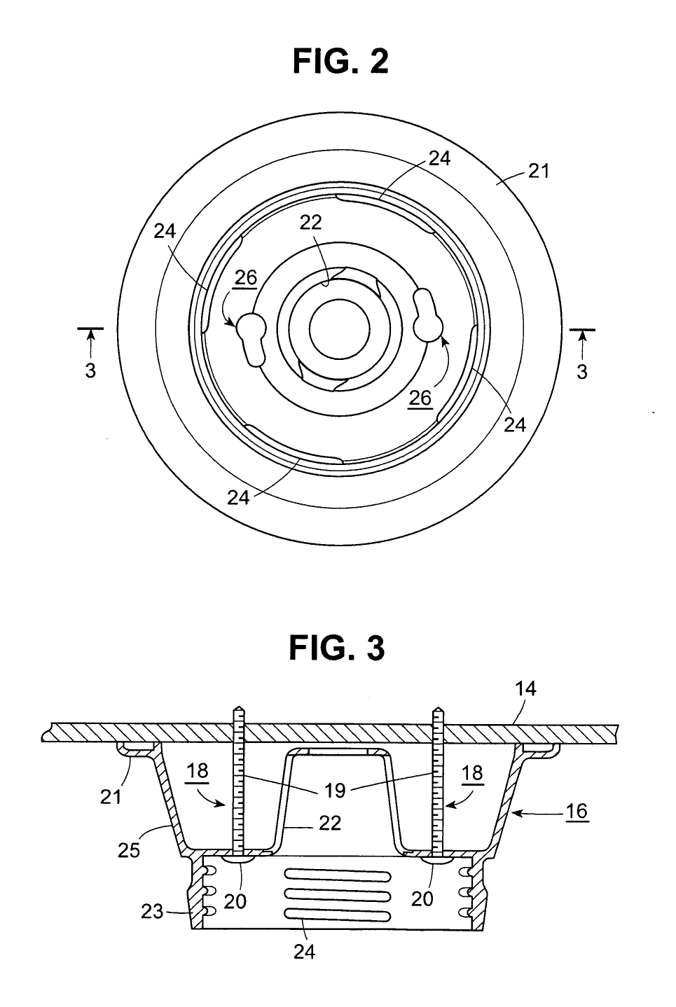

FIG. 2 illustrates a bottom view of a housing for an incandescent light bulb having slots in accordance with the invention;

FIG. 3 illustrates a cross-sectional view taken on line 3-3 of FIG. 2; and

FIG. 4 illustrates an enlarged view of a key-shaped slot in accordance with the invention.

Referring to FIG. 1, a canopy type hood 10 is typically mounted on a wall 11 over a cooking stove 12 or other type of cooking equipment in order to draw off heated air created on the cooking surface of the stove 12. As illustrated, the hood 10 is typically of a box-shaped construction that defines a chamber 13 for receiving an upward flow of heated air from a cooking surface of the stove 12. In addition, the hood 10 has a ceiling above the chamber 13 from which a pre-wired lighting 15 depends.

The lighting fixture 15 includes a housing 16 which is secured to the ceiling 14 and a globe 17 that is mounted in the housing 16.

Referring to FIGS. 2 and 3, the housing 16 is secured to the ceiling 14 of the hood by means of a pair of mounting screws 18. As indicated in FIG. 3, each mounting screw 18 has a shank 19 that is threaded into the sheet metal ceiling 14 in a conventional manner. The screws 18 are pre-assembled in the ceiling 14 and stand proud from the ceiling 14 before mounting of the lighting fixture 15 in place. Also, each mounting screw 18 has an enlarged head 20 spaced from the ceiling 14.

The hood 10 is typically made of sheet metal, such as stainless steel.

The housing 16 is of bowl-shape with a cylindrical collar 21 that seats against the ceiling 14. In addition, the housing 16 includes a socket 22 that is internally threaded in order to receive an incandescent light bulb (not shown) centrally of the housing 16. In addition, the housing 16 has an annular collar 23 concentric to the socket 22 that is internally provided with a partial thread 24 in order to threadably receive the globe 17 (see FIG. 1).

Referring to FIG. 3, the housing 16 has a base 25 of circular shape that is concentric to the socket 22 and that is spaced from the collar 21. This base 25 includes a pair of key-shaped slots 26 that are disposed in diametrically opposite portions of the base 25 to receive the mounting screws 18 (see FIG. 3).

Referring to FIGS. 3 and 4, each key-shaped slot has an enlarged portion 27 of a size to permit passage of the head 20 of a respective mounting screw 18 and an adjacent smaller portion 28 of a size to permit passage of the shank 19 of a mounting screw 18 or to prevent passage of the head 20 of the mounting screw. As indicated in FIG. 2, the enlarged portion 27 of each slot 26 is directed in a clockwise direction relative to the smaller portion 28 and relative to the vertical axis of the housing 16, i.e. to the right as viewed. As shown in FIG. 4, the enlarged portion 27 is of part circular shape and the smaller portion 28 is of part-elliptical shape, that is, of elongated elliptical shape of a width smaller than the diameter of the enlarged portion 27.

The hood 10 is initially provided with the pair of mounting screws 18 in the ceiling 14. In order to thereafter mount the housing 16 in place, the housing 16 is placed within the chamber 13 of the hood 10 so that the larger portions 27 of the two slots 26 are aligned with the heads 20 of the mounting screws 18. The housing 16 is then passed over the screw heads 20 until the collar 21 abuts against the ceiling 14. At this time, the heads 20 of the mounting screws 18 project beyond the plane of the housing 16.

Next, the housing 16 is rotated clockwise so that the smaller portions 28 of the slots 26 pass over the shanks 19 of the screws 18. This allows the housing 16 to remain mounted prior to tightening the screws 18.

The mounting screws 18 are then tightened, i.e. rotated clockwise, so as to abut the heads 20 of the screws 18 against the base 25 of the housing 16. During the rotation of the screws 18, each head 20 comes into frictional contact with the base so that continued rotation of the screws 18 imparts a rotational movement on the housing 16 in a clockwise direction. This brings the shank 19 of each screw 18 into abutment with the base 25 at the end of the smaller portion 28 of the slot 26, should the shank 19 not be at that position.

After tightening of the two mounting screws 18, the heads 20 of the mounting screws 18 abut against the base 25. The housing 16 is thus firmly held in place against the ceiling 14.

Thereafter, an incandescent light bulb may be threaded into the socket 22 by rotating in a clockwise direction. Tightening of the light bulb occurs in a clockwise direction and is resisted by the housing 16 being abutted against the shanks 19 of the mounting screws 18.

Thereafter, the globe 17 may be mounted in the collar 23 on the partial threads 24 in a conventional manner. During this time, any clockwise rotation of the globe within the socket 23 is resisted by the abutment of the housing 16 against the shanks 19 of the mounting screws 18. This reduces the risk that a loosening of the mounting screws 18 could lead to the light housing 16 becoming so loose as to fall out of the exhaust hood 10 onto a cooking surface or onto a worker.

The invention thus provides an incandescent light housing for an exhaust hood that can be firmly mounted in place. Further, the invention insures that the mounting of the incandescent light housing in place remains secure during tightening of the mounting screws, installation of a light bulb and installation of a globe.

1. The combination of
an exhaust hood defining a chamber for receiving an upward flow of heated air from a cooking surface;
at least one pair of mounting screws threadably mounted in said hood within an interior of said chamber, each said screw having a shank of a predetermined diameter with a thread for rotation of said shank in a clockwise direction into said hood and a head of greater diameter than said predetermined diameter of said shank projecting into said head; and
a light housing disposed in said hood, said housing having a base including a pair of key-shaped slots, each said slot having a first portion of a size to permit passage of said head of a respective screw therethrough and a second portion of a size to permit passage of said shank of said respective screw therethrough and to prevent passage of said head of said respective screw therethrough, said first portion of each said slot being directed in a clockwise direction relative to said second portion.

2. The combination as set forth in claim 1 wherein said housing has a threaded socket for receiving an incandescent light bulb.

3. The combination as set forth in claim 2 wherein said housing has an annular collar concentric to said socket and further comprises a globe mounted in said collar over said threaded socket.

4. The combination as set forth in claim 1 wherein said first portion of each said slot is of part-circular shape and said second portion of each said slot is of a part-elliptical shape smaller than the diameter of said first portion.

5. A light housing for an exhaust hood comprising
a base including a pair of key-shaped slots, each said slot having an enlarged first portion of a size to permit passage of a head of a screw mounted in the hood therethrough and a smaller second portion of a size to permit passage of a shank of the screw therethrough and to prevent passage of the head of the screw therethrough, said enlarged first portion of each said slot being directed in a clockwise direction relative to said smaller second portion.

6. A light housing as set forth in claim 5 further comprising a threaded socket on said base for receiving an incandescent light bulb.

7. A light housing as set forth in claim 5 further comprising an annular collar on said base concentric to said socket for receiving a globe.

8. A light housing as set forth in claim 5 wherein said first portion of each said slot is of part-circular shape and said second portion of each said slot is of a part-elliptical shape smaller than the diameter of said first portion.
